(19) United States
(12) Patent Application Publication
(10) Pub. No.: US 2016/0059249 A1
(43) Pub. Date: Mar. 3, 2016

(54) ELECTROSPRAY WITH SOFT X-RAY NEUTRALIZER

(71) Applicant: TSI, Inc., Shoreview, MN (US)

(72) Inventors: JACOB HACKBARTH SCHECKMAN, Minneapolis, MN (US); Frederick Quant, Shoreview, MN (US); Tony Hase, White Bear Township, MN (US)

(21) Appl. No.: 14/835,990

(22) Filed: Aug. 26, 2015

Related U.S. Application Data
(60) Provisional application No. 62/041,832, filed on Aug. 26, 2014.

(51) Int. Cl. B05B 5/00; B05B 5/03

(52) U.S. Cl. CPC B05B 5/002; B05B 5/03

(57) ABSTRACT

The electrospray generator system described herein uses a soft X-ray source instead of a radioactive source to generate bipolar ions for the neutralization of the initially charged particles. In one example, the soft X-ray source is directed at an orifice from which the charged particles emanate, thereby allowing the neutralization of the particles to happen faster than in prior art configurations and, in some instances, even neutralization occurring immediately on a droplet before it passes through the electrospray orifice.

### PRIORITY CLAIM

The present nonprovisional patent application claims the benefit of and priority, under 35 USC §119(e), from U.S. Provisional Patent Application No. 62/041,832, filed on Aug. 26, 2014, entitled “ELECTROSPRAY WITH SOFT X-RAY NEUTRALIZER,” the entirety of which is incorporated herein by reference.

### FIELD AND BACKGROUND OF THE INVENTION

The invention generally relates to electrospray aerosol generators.

A prior art charge-neutralized electrospray aerosol generator is disclosed by Kaufman et al., in U.S. Pat. No. 5,247,842 and is manufactured by TSI, Inc. as, by way of example, Electrospray Aerosol Generator Model 3480. This device generates small, highly charged liquid droplets and accelerates them through a small orifice into a neutralization chamber where their high charge states are reduced by a radioactive (bipolar) neutralizer. The liquid droplets contain dissolved materials or suspended solid particles. As soon as the droplets are generated they begin drying such that when they enter the neutralization chamber they have dried to solid particles.

The charge fraction of particles after passing through the neutralization chamber is determined by the size of the final dried particles, hence the smaller the particle is, the lower the charged fraction. Since the charged particles are used for subsequent analysis, achieving higher charge fractions or allowing a higher proportion of droplets generated by the electrospray device to be neutralized before they are lost would be advantageous.

### SUMMARY OF THE INVENTION

The various embodiments of the invention provide an electrospray generator system that uses a soft X-ray source instead of a radioactive source to generate bipolar ions for the neutralization of the initially charged particles. In this example embodiment, the soft X-ray source is directed at an orifice from which the charged particles emanate. This allows the neutralization of the particles to happen faster than in prior art configurations and in some instances even neutralization occurs immediately on a droplet before it passes through the electrospray orifice. The various embodiments of the invention improve output charged particles with low charge state (e.g. one charge per particle) of electrospray aerosol generator. An advantage of the electrospray aerosol generator taught herein is a compact design that eliminates structural parts in using a soft X-ray neutralizer component in a “head on” orientation that increases usable droplet output. In a related embodiment, the “head on” orientation includes a blocking or shielding member, disposed in front of the capillary tube generating droplets, that prevents the soft X-ray irradiation from disrupting the electric field around the end of the capillary tube (which can lead to a condition of corona discharge).

In one example embodiment, an apparatus for generating aerosols is provided that includes an electrospray assembly, having an electrospray inlet and a discharge outlet, for receiving a liquid sample at the electrospray inlet and electrostatically generating multiple substantially uniformly sized electrically charged droplets of the liquid sample at the discharge outlet, the electrospray assembly further including an electrospray chamber with a blocking or shielding member located adjacent and not in contact with the discharge outlet. The apparatus further includes a mechanism for supplying the liquid sample to the electrospray assembly and a charge neutralizing assembly disposed in a head-on or co-linear configuration with the discharge outlet for reducing the electrical charge of each droplet of the liquid sample as the droplet exits the electrospray assembly, wherein the neutralizing assembly comprises a soft X-ray source. The blocking member of the electrospray assembly advantageously prevents an output of the soft X-ray source from impinging directly onto the source of the electrically charged droplets. In a more specific embodiment, the discharge outlet comprises a capillary tube that forms a cone jet configuration at an exit of the tube from the liquid sample, wherein the stability of the cone jet of the liquid sample is maintained by the blocking member thereby facilitating continuous formation of droplets. In yet another related embodiment, the electrospray device includes an evaporation or electrospray chamber defining a droplet evaporation region proximate the electrospray discharge outlet and extending downstream thereof, for reducing the size of the droplets by evaporation as the droplets progress downstream through the evaporation region, to form an aerosol of the sample, wherein the liquid sample comprises an electrically conductive liquid and a substantially non-volatile material uniformly dispersed throughout the liquid, and wherein the aerosol includes particles of a substantially non-volatile residue consisting essentially of the non-volatile material.

The novel features of the various embodiments the invention itself, both as to its construction and its method of operation, together with additional advantages thereof, will be best understood from the following description of specific embodiments when read in connection with the accompanying drawings.

### BRIEF DESCRIPTION OF THE DRAWINGS

Other important advantages of the invention will be apparent from the following detailed description of the invention taken in connection with the accompanying drawings in which:

FIG. 1 is a schematic view of an electrospray generator system with a pump and autosampler device, coupled with a Scanning Mobility Particle Sizing (SMPS) system in accordance with the invention;

FIG. 2 is an electrospray system without a pump and autosampler device in accordance with an example embodiment of the invention;

FIG. 3 is a block diagram of the electrospray system in accordance with the invention;

FIG. 4 is a cross sectional top view of an electrospray engine in accordance with the invention;

FIG. 5 is a cross sectional side view of an electrospray engine in accordance with the invention; and

FIGS. 6A and 6B are a cross sectional top view and a schematic, respectively, of an electrospray engine with a radiation blocking feature in a neutralization chamber in accordance with the invention.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

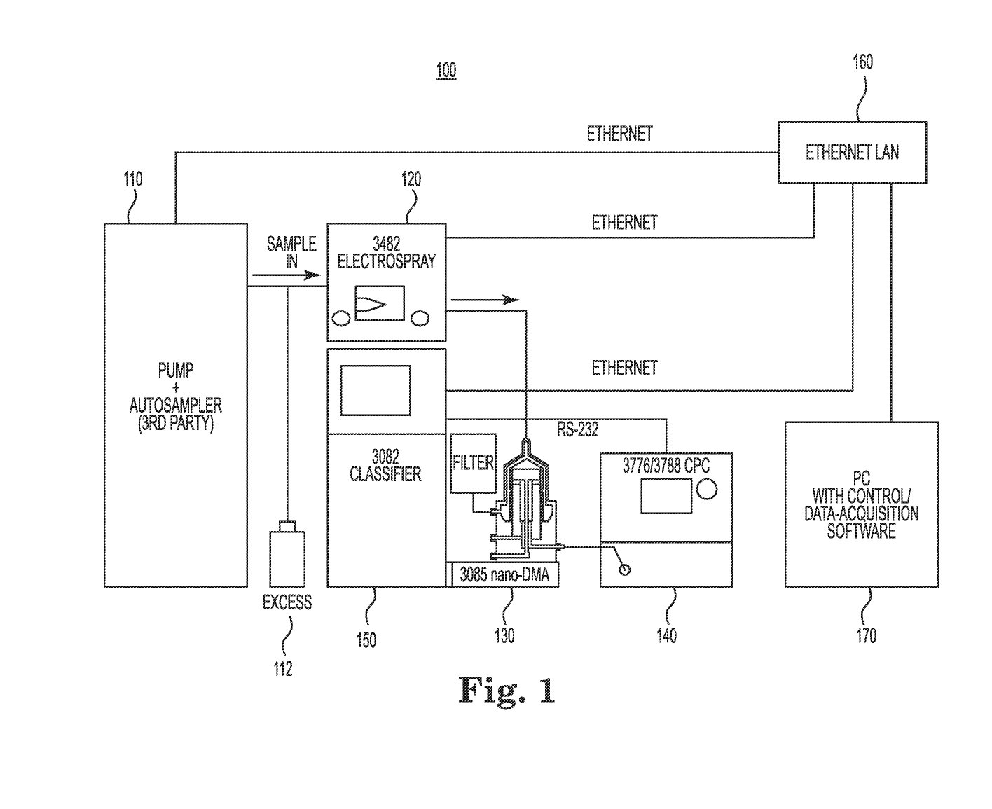

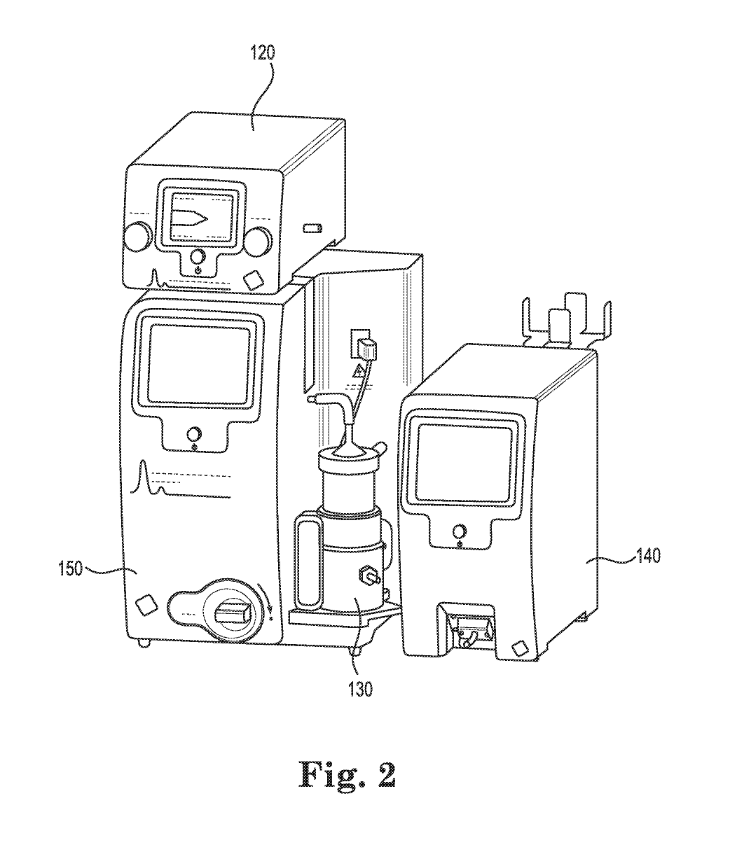

Referring now to the figures, and in particular FIGS. 1 and 2, there is illustrated a schematic and pictorial view, respectively, of an electrospray generator system 100 in accordance with the invention. In this example embodiment, electrospray system 100 includes a pump and autosampler assembly 110 for automated liquid delivery of a sample to be analyzed. Assembly 110 directs a sample into an electrospray apparatus 120 configured for aerosol generation with any excess sample being captured by a vessel 112. In this example embodiment, an electrospray of droplets is directed to a nano-DMA 130 (differential mobility analyzer; TSI Model 3085), which is controlled by an electrostatic classifier 150 (such as a TSI Model 3082), for sizing the particles of which are directed to a CPC 140 (condensation particle counter). CPC 140 can either be a butanol-based device (TSI Model 3776) or a water-based ultrafine device (TSI Model 3788).

In this example embodiment, CPC 140 also has an RS 232 communications line coupled to classifier 150. Further, in this example embodiment, most of the devices are communicatively connected via an Ethernet line back to an Ethernet LAN 160, which is in turn communicatively connected to a PC with instrument control/data acquisition software 170. The combination of electrostatic classifier, DMA and CPC, along with instrument control/data acquisition software is commonly referred to as a Scanning Mobility Particle Sizer (SMPS, such as a TSI Model 3938).

FIG. 2 illustrates pictorially part of system 100, such as electrospray apparatus 120, nano-DMA 130, CPC 140 and classifier 150. In this example embodiment, electrospray 120 is configured with a non-radioactive soft X-ray neutralizer (not shown) for neutralizing the electrospray droplets. Partial system 100 illustrated herein is compatible with a 3^{rd} party supplied pump and autosampler. In a related embodiment, system 100 includes a camera for viewing of the electrospray output and includes electronic flow measurement capabilities and includes a touch screen.

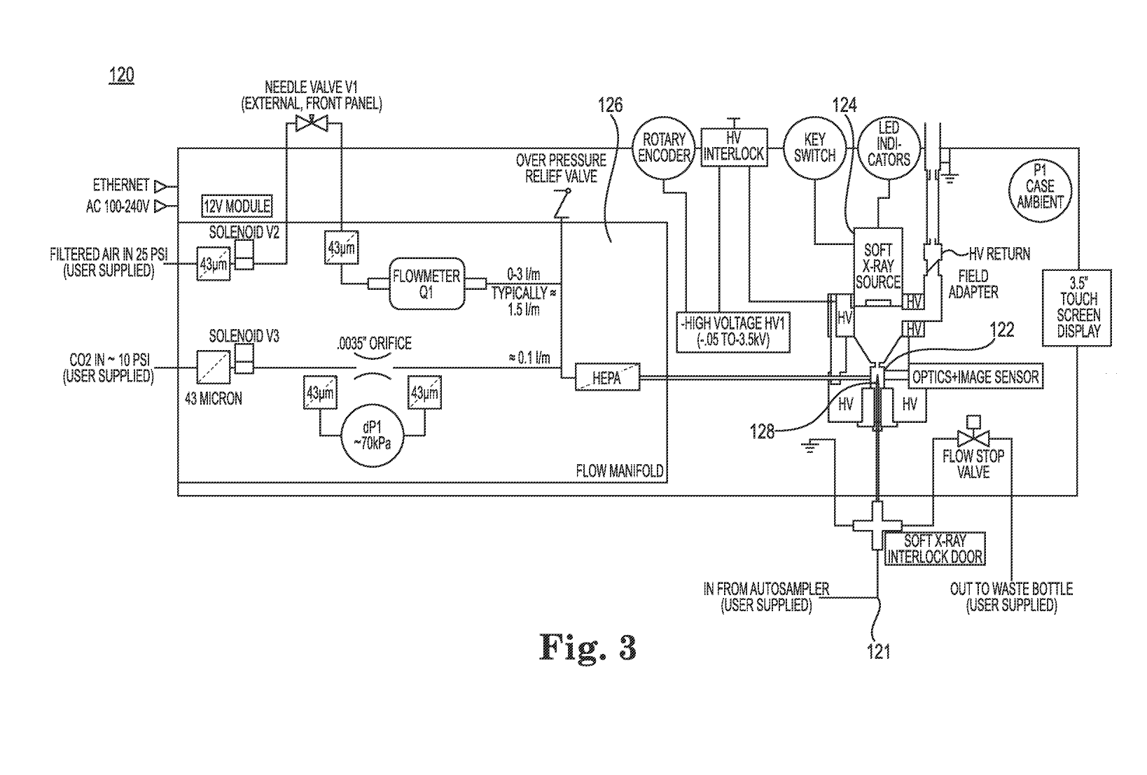

Referring now to FIG. 3 there is illustrated a block diagram of electrospray system 120 in accordance with the invention. In particular, sample liquid from the autosampler flows into electrospray system 120 through an inlet 121 and through an electrospray needle 122 that is in a “head on” configuration with a soft X-ray module 124. An output of electrospray droplets from needle 122 is exposed to soft X-ray radiation from module 124 in a chamber 128 thereby neutralizing the droplets emitted by needle 122. Filtered air is also provided through a flow manifold assembly 126 into chamber 128 in which the droplets are being neutralized. Ethernet and power connections to system 120 are also illustrated.

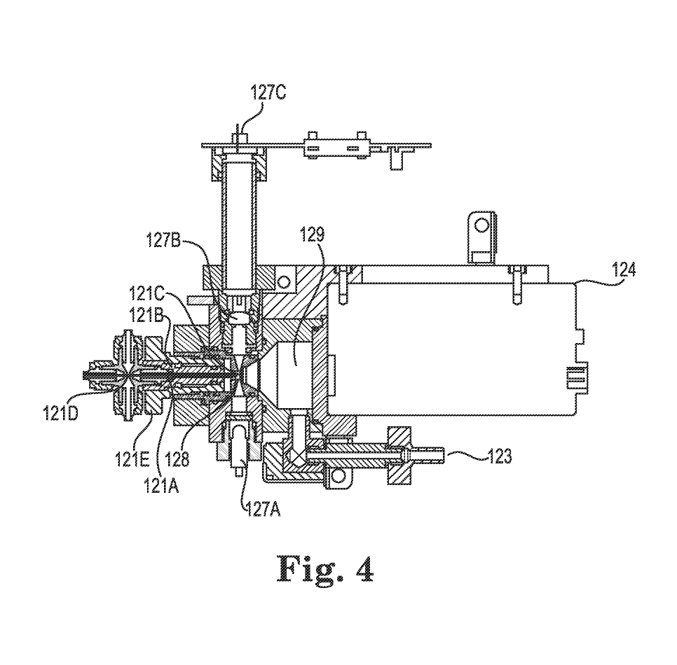

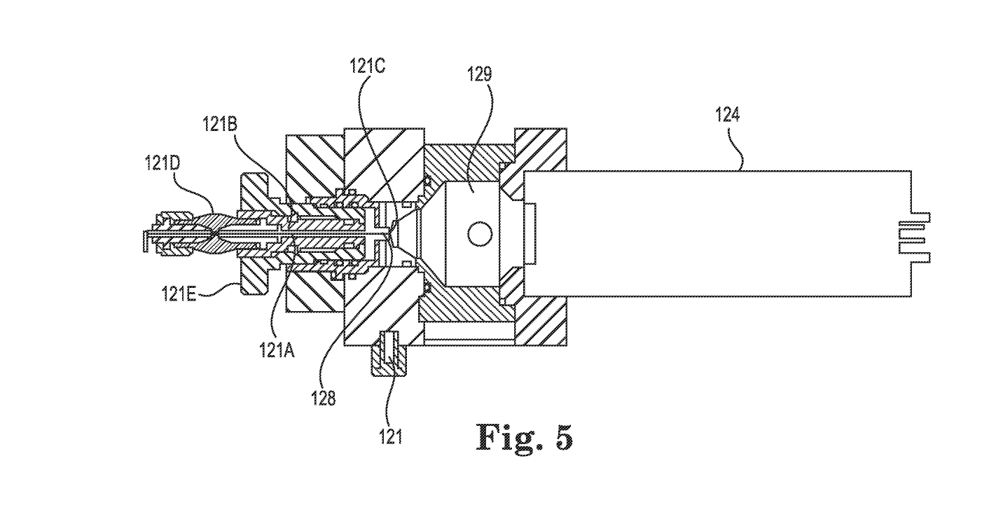

Referring now to FIGS. 4 and 5, there are shown cross sectional top and side views, respectively, of an electrospray engine 120A of electrospray system 120 in accordance with the invention. In this example embodiment, a TSI 3482 Advanced Electrospray Aerosol Generator uses a soft X-ray neutralizer oriented in a “head-on” configuration, similar to more recent configurations, but different than being oriented perpendicular to the electrospray orifice as in prior generations of electrospray devices. Unlike similar collinear configurations, the invention described herein uses a blocking or shielding member (discuss in detail further down in this application) and others in the art have recognized the performance issues when only a collinear configuration is used (e.g., Liu and Chen (2014) “An electrospray aerosol generator with X-ray photoionizer for particle charge reduction”. Journal of Aerosol Science. 76, 148-162). In addition, these prior collinear configurations appear to use a significantly larger orifice or inlet (such as our inlet 121C) into the neutralization chamber than in the electrospray device described herein.

Referring specifically again to FIGS. 4 and 5, in this example embodiment, a capillary tube 121A serving as an electrospray needle and coupled to a liquid flow split tee 121D is held in place by a capillary tube holder 121B (and adjustable with a capillary adjustment knob 121E) such that an aerosol inlet 121C is formed that is directed through an electrospray (or evaporation) chamber 128 through to a neutralization chamber 129. While the droplets are in the neutralization chamber, soft X-ray module 124 emits X-rays and neutralizes any charges on the droplets. This configuration facilitates a smaller footprint and eliminates unnecessary parts, such as filtering plates, and increases the efficiency of producing neutralized particles that are produced by this arrangement. In this example embodiment, an LED backlight 127A, camera optics 127B and an image sensor 127C are also included for viewing and inspection of electrospray stability.

In operation, liquid flows through capillary tube 121A while a clean sheath of air flows around the tip of tube 121A. Meanwhile, an electric field pulls the liquid out from the tube forming a cone jet. Thereafter, liquid droplets of about 150 nm in diameter containing particles shear off the tip of the cone. The droplets are initially very highly charged, upon which the neutralizer reduces the charge of the droplets (in this example embodiment, by soft X-ray irradiation). The charge-neutralized droplet then dry, leaving charge-neutralized nanoparticles.

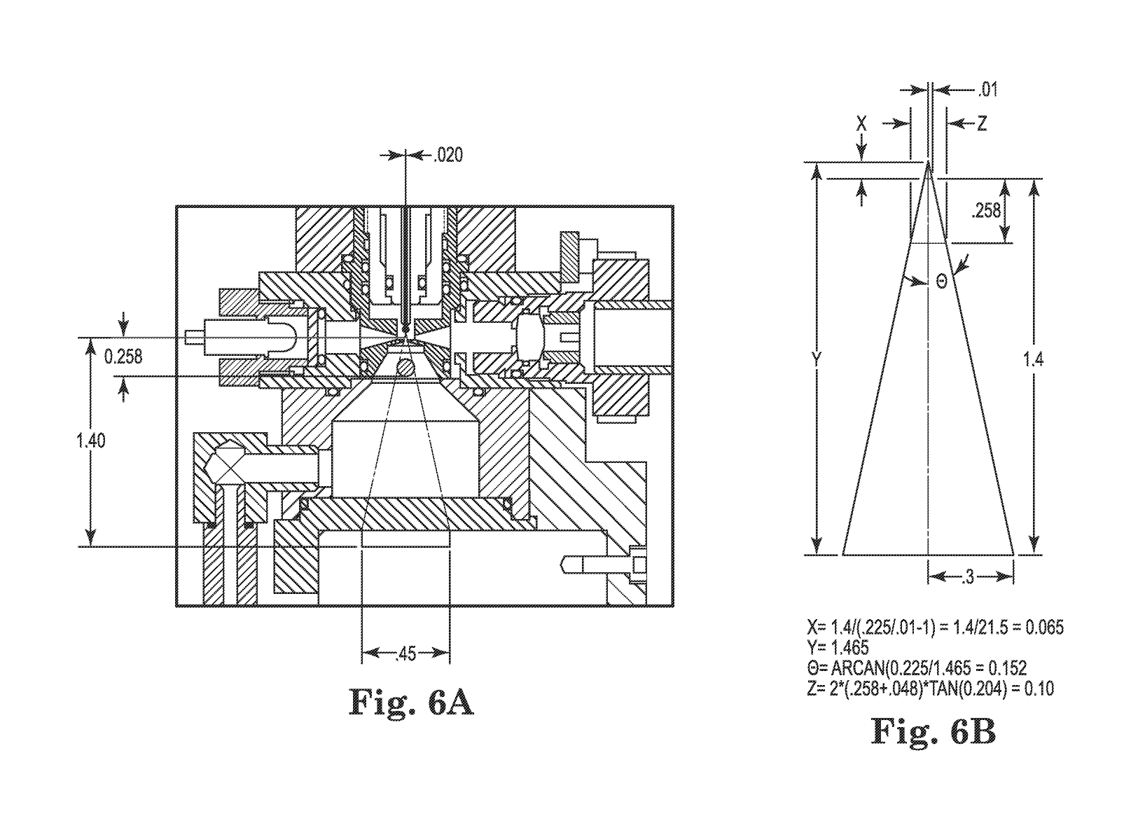

Referring now to FIGS. 6A and 6B, there are illustrated a cross sectional top view and a schematic, respectively, of an electrospray engine 120B with a radiation blocking member 128A in neutralization chamber 129 in accordance with the invention. The various components of this example embodiment are similar to the embodiment illustrated in FIG. 4 with the exception of the radiation blocking member 128A, which in this example embodiment acts to block soft X-rays from impinging directly on the droplets formed from the cone jet and the end of the capillary tube. It was determined in some applications that the direct impinging of soft X-ray irradiation on or towards the tip of the capillary tube (or stream of droplets) would tend to ionize air molecules around the exit of tube 121A, thereby disrupting the electric field around the cone jet leading to an unstable cone jet (and to a corona discharge condition). By adding a blocking or shield member 128A inside the electrospray chamber 128, in this example embodiment, which is spaced from the end of tube 121A and the cone jet, the soft X-ray waves that would normally impinge on the droplets directly are disrupted sufficiently to avoid the soft X-rays from disrupting the electric field around the end of the capillary tube. In this example embodiment, blocking member 128A is a rod or a bar member.

Referring to FIG. 6B, an important element in the design and placement of blocking member 128A is determining the value of Z, which is theoretically a minimum 0.1 inches but is still an effective diameter for the shield/baffle/blocking member. In a preferred embodiment, we use a diameter of about 0.125 inches (or larger than this for a factor of safety and performance). A dimension X from the electrospray orifice plate to the blocking member (the shorter dimension on the left; in inches) is provided as well as a dimension from the electrospray orifice plate to the soft X-ray source (the longer dimension on the left; in inches). Measurements of soft X-ray intensity without blocking member in the electrospray chamber were at about 5.0 μSv/hr, while the soft X-ray intensity with the blocking member were at about 0 μSv/hr. Therefore, the stability of the cone jet of the liquid sample is maintained by the blocking member thereby facilitating continuous and uninterrupted formation of droplets discharged by the capillary tube.

The following patents and publications are incorporated by reference in their entireties: U.S. Pat. Nos. 5,247,842; 7,522,703; 7,796,727; and Soft X-ray charger (SXC) system for use with electrospray for mobility measurement of bioaerosols. Journal of Electrostatics, 69(4), 357-364, Modesto-Lopez, L. B., Kettleson, E. M., & Biswas, P. (2011).

The foregoing specific embodiments of the present invention as set forth in the specification herein are for illustrative purposes only. Various deviations and modifications may be made within the spirit and scope of the invention without departing from the main theme thereof.

What we claim is:

1. An apparatus for generating aerosols comprising:
an electrospray assembly, having an electrospray inlet and a discharge outlet, for receiving a liquid sample at the electrospray inlet and electrostatically generating multiple substantially uniformly sized electrically charged droplets of the liquid sample at the discharge outlet, the electrospray assembly further including an electrospray chamber with a blocking or shielding member located adjacent and not in contact with the discharge outlet;
a mechanism for supplying the liquid sample to the electrospray assembly; and
a charge neutralizing assembly disposed in a head-on or co-linear configuration with the discharge outlet for reducing the electrical charge of each droplet of the liquid sample as the droplet exits the electrospray assembly, wherein the neutralizing assembly comprises a soft X-ray source, wherein the blocking member prevents an output of the soft X-ray source from impinging directly onto the source of the electrically charged droplets.

2. The apparatus of claim 1 wherein the discharge outlet comprises a capillary tube that forms a cone jet configuration at an exit of the tube from the liquid sample, wherein the stability of the cone jet of the liquid sample is maintained by the blocking member thereby facilitating continuous formation of droplets.

3. The apparatus of claim 1 further comprising:
an evaporation chamber defining a droplet evaporation region proximate the electrospray discharge outlet and extending downstream thereof, for reducing the size of the droplets by evaporation as the droplets progress downstream through the evaporation region, to form an aerosol of the sample; and
wherein the liquid sample comprises an electrically conductive liquid and a substantially non-volatile material uniformly dispersed throughout the liquid, wherein the aerosol includes particles of a substantially non-volatile residue consisting essentially of the material.

4. The apparatus of claim 1 further including a particle counting apparatus disposed downstream of the neutralizing assembly to receive the aerosol.

5. The apparatus of claim 4 wherein the particle counting apparatus is a condensation particle counter.

6. The apparatus of claim 4 further comprising a particle separation device disposed downstream of the neutralization assembly to receive the aerosol and separate particles of the aerosol based upon the electrical mobility of the individual particles.

7. The apparatus of claim 6 wherein the particle separation device comprises an electrostatic classifier.

8. The apparatus of claim 4 further including a particle analyzing device disposed downstream of the evaporation region to receive the aerosol.

9. The apparatus of claim 8 wherein the particle analyzing device includes an electrostatic classifier receiving the aerosol and a condensation particle counter disposed downstream of the electrostatic classifier.

10. The apparatus of claim 1 wherein the blocking member includes one of a bar member having a diameter greater than 0.1 inches or a plate member having a width greater than 0.1 inches.
